(19) United States
(12) Patent Application Publication
(10) Pub. No.: US 2026/0024373 A1
(43) Pub. Date: Jan. 22, 2026

(54) FINGERPRINT MODULE AND ELECTRONIC DEVICE

(71) Applicant: HUIKE (SINGAPORE) HOLDING PTE. LTD., Singapore (SG)

(72) Inventors: Wenzheng LIU, Shenzhen (CN); Kai LIU, Shenzhen (CN)

(73) Assignee: HUIKE (SINGAPORE) HOLDING PTE. LTD., Singapore (SG)

(21) Appl. No.: 19/341,462

(22) Filed: Sep. 26, 2025

Related U.S. Application Data
(63) Continuation of application No. PCT/CN2024/074467, filed on Jan. 29, 2024.

(51) Int. Cl. G06V 40/13; B32B 5/18; B32B 7/04

(52) U.S. Cl. CPC G06V 40/1306; B32B 5/18; B32B 7/04; B32B 2457/00

(57) ABSTRACT

A fingerprint module and an electronic device are provided. The fingerprint module includes: a ultrasonic module arranged on a substrate. The substrate is provided with a first electrical connection area, a circuit board is provided with a second electrical connection area, the first electrical connection area is electrically connected to the second electrical connection area through a conductive adhesive layer; a buffer layer is arranged between a ultrasonic sensor and a support structure on the electronic device, and the ultrasonic sensor is configured to convert the received ultrasonic signal into an electrical signal, and send the electrical signal to the processing unit through the circuit board, so that the processing unit performs fingerprint recognition.

### CROSS REFERENCE TO RELATED APPLICATIONS

The present disclosure is a continuation application of PCT/CN2024/074467 filed on Jan. 29, 2024 titled “FINGERPRINT MODULE AND ELECTRONIC DEVICE”, which is in incorporated herein by reference in its entirety.

### TECHNICAL FIELD

Embodiments of the present disclosure relate to the technical field of a fingerprint module, and particularly relate to a fingerprint module and an electronic device.

### BACKGROUND

Two main solutions for under-screen fingerprint recognition have been disclosed: the first is an optical fingerprint solution, and the second is an ultrasonic fingerprint solution. Performance of the optical fingerprint module is greatly affected by light transmittance of a screen. With the increase of complexity of internal wiring of a display screen and the development of factors such as a flexible screen solution, optical transmittance of the screen is reduced, so that the optical fingerprint solution fails to satisfy the application requirements. However, the ultrasonic fingerprint solution is a better alternative solution without relying on the optical transmittance of the screen.

A fingerprint module in the existing ultrasonic fingerprint solution is arranged between a screen and a support structure in an electronic device.

However, when the electronic device is subjected to an external impact, the fingerprint module arranged between the screen and the support structure is subjected to a high stress and tends to break, thereby damaging the fingerprint module.

### SUMMARY

In view of this, embodiments of the present disclosure provide a fingerprint module and an electronic device, to at least partially solve the above problems.

According to an embodiment in a first aspect of the present disclosure, a fingerprint module is provided, which is applied to an electronic device, and comprises: an ultrasonic sensor, a circuit board, and a buffer layer; wherein the ultrasonic sensor comprises a substrate and an ultrasonic module, the ultrasonic module is arranged on the substrate, the substrate is provided with a first electrical connection area, the circuit board is provided with a second electrical connection area, the first electrical connection area is electrically connected to the second electrical connection area through a conductive adhesive layer; the buffer layer is arranged between the ultrasonic sensor and a support structure on the electronic device; the circuit board is electrically connected to a processing unit of the electronic device, the ultrasonic module is configured to transmit an ultrasonic signal and receive an ultrasonic signal reflected from an external structure, and the ultrasonic sensor is configured to convert the ultrasonic signal received by the ultrasonic module into an electrical signal, and send the electrical signal to the processing unit through the circuit board, so that the processing unit performs fingerprint recognition based on the electrical signal.

In a possible implementation, a projection of the ultrasonic module on the buffer layer along a direction perpendicular to the substrate is located within an edge of the buffer layer; and a projection of the second electrical connection area along the direction perpendicular to the substrate intersects with the buffer layer.

In a possible implementation, the buffer layer contacts the circuit board and the ultrasonic module along the direction perpendicular to the substrate.

In a possible implementation, along the direction perpendicular to the substrate, there is a first gap between the buffer layer and the circuit board, and there is a second gap between the buffer layer and the ultrasonic module.

In a possible implementation, a projection of the ultrasonic module on the buffer layer along a direction perpendicular to the substrate is located within an edge of the buffer layer; and a projection of the second electrical connection area along the direction perpendicular to the substrate does not intersect with the buffer layer.

In a possible implementation, the circuit board comprises a base material and the second electrical connection area arranged on the base material, the base material exceeds the second electrical connection area at one terminal of the circuit board close to the ultrasonic module, and a projection of the base material along the direction perpendicular to the substrate intersects with the buffer layer.

In a possible implementation, the buffer layer comprises a first buffer layer and a second buffer layer connected to each other, a projection of the first buffer layer on the substrate along the direction perpendicular to the substrate is located within an edge of the substrate in a first direction, a projection of the base material along the direction perpendicular to the substrate intersects with the first buffer layer, and a projection of the ultrasonic module on the second buffer layer along the direction perpendicular to the substrate is located within an edge of the second buffer layer, wherein the first direction is perpendicular to a direction of the circuit board pointing to the ultrasonic module and perpendicular to the substrate.

In a possible implementation, along the direction perpendicular to the substrate, the first buffer layer contacts the base material, and the second buffer layer contacts the ultrasonic module.

In a possible implementation, along the direction perpendicular to the substrate, there is a third gap between the first buffer layer and the base material, and there is a fourth gap between the second buffer layer and the ultrasonic transmission module.

In a possible implementation, projections of the circuit board and the conductive adhesive layer along the direction perpendicular to the substrate do not intersect with the buffer layer.

In a possible implementation, the buffer layer contacts the ultrasonic module along the direction perpendicular to the substrate.

In a possible implementation, there is a fifth gap between the buffer layer and the ultrasonic module along the direction perpendicular to the substrate.

In a possible implementation, the buffer layer comprises a buffer foam having a density in a range of [0.01 g/cm³, 0.5 g/cm³].

According to an embodiment in a second aspect of the present disclosure, an electronic device is provided, comprising: a processing unit, a screen, a support structure, and the fingerprint module according to the first aspect of the present disclosure; wherein the fingerprint module is arranged between the screen and the support structure, and a buffer layer in the fingerprint module is arranged between an ultrasonic sensor in the fingerprint module and the support structure, wherein the support structure comprises a middle frame or a battery of the electronic device; the processing unit is electrically connected to the fingerprint module; and the processing unit is configured to perform fingerprint recognition based on an electrical signal transmitted from the fingerprint module.

According to a fingerprint module provided in the embodiments of the present disclosure, the fingerprint module comprises an ultrasonic sensor, a circuit board, and a buffer layer, wherein the buffer layer is arranged between the ultrasonic sensor and a support structure on the electronic device, so that when the electronic device is subjected to an external impact, the fingerprint module can be buffered through the buffer layer, thereby reducing a stress to which the fingerprint module is subjected, preventing the fingerprint module from being broken when the electronic device is subjected to the external impact, and preventing the fingerprint module from being damaged.

### BRIEF DESCRIPTION OF DRAWINGS

To more clearly describe technical solutions of embodiments of the present disclosure or the prior art, drawings to be used in the description of the embodiments or the prior art will be briefly introduced below. Apparently, the drawings in the description below are merely some embodiments disclosed in the embodiments of the present disclosure. For those of ordinary skills in the art, other drawings may also be obtained based on these drawings.

FIG. 1 is a schematic diagram of a fingerprint module provided in an embodiment of the present disclosure;

FIG. 2 is a schematic diagram of another fingerprint module provided in an embodiment of the present disclosure;

FIG. 3 is a schematic top view of a fingerprint module provided in an embodiment of the present disclosure;

FIG. 4 is a schematic diagram of still another fingerprint module provided in an embodiment of the present disclosure;

FIG. 5 is a schematic top view of another fingerprint module provided in an embodiment of the present disclosure;

FIG. 6 is a schematic diagram of yet another fingerprint module provided in an embodiment of the present disclosure;

FIG. 7 is a schematic diagram of yet another fingerprint module provided in an embodiment of the present disclosure;

FIG. 8 is a schematic diagram of yet another fingerprint module provided in an embodiment of the present disclosure;

FIG. 9 is a schematic top view of still another fingerprint module provided in an embodiment of the present disclosure; and

FIG. 10 is a schematic diagram of an electronic device provided in an embodiment of the present disclosure.

### DETAILED DESCRIPTION

To enable those skilled in the art to better understand technical solutions of embodiments of the present disclosure, the technical solutions of the embodiments of the present disclosure will be clearly and completely described below with reference to the drawings in the embodiments of the present disclosure. Apparently, the described embodiments are merely some, instead of all, of the embodiments of the present disclosure. All other embodiments obtained by those of ordinary skills in the art based on some embodiments among the embodiments of the present disclosure should be encompassed within the scope of protection of the embodiments of the present disclosure.

The terms used in the present disclosure are intended merely to describe particular embodiments, and are not intended to limit the present disclosure. The singular forms of “a” and “the” used in the present disclosure and the appended claims are also intended to include plural forms, unless the context explicitly indicates other meanings. It should be further understood that the term “and/or” used herein refers to and includes any or all possible combinations of one or more associated enumerated items.

It should be understood that various kinds of information may be described by using the terms, such as first, second, and third, in the present disclosure, but the information should not be limited to these terms. These terms are merely used to distinguish between information of a same type. For example, the first piece of information may also be called the second piece of information, and similarly, the second piece of information may also be called the first piece of information, without departing from the scope of the present disclosure. Depending on the context, as used herein, the word “if” may be interpreted as “at the time of . . . ” or “when . . . ” or “in response to determining.”

As mentioned above, a fingerprint module in the existing ultrasonic fingerprint solution is arranged between a screen and a support structure in an electronic device. However, when the electronic device is subjected to an external impact (for example, the electronic device is subjected to a mechanical impact or falls off), the fingerprint module arranged between the screen and the support structure is subjected to a high stress and tends to break, thereby damaging the fingerprint module. Therefore, it is necessary to protect the fingerprint module.

The present disclosure provides a fingerprint module. The fingerprint module comprises an ultrasonic sensor, a circuit board, and a buffer layer, wherein the buffer layer is arranged between the ultrasonic sensor and a support structure on the electronic device, so that when the electronic device is subjected to an external impact, the fingerprint module can be buffered through the buffer layer, thereby reducing a stress to which the fingerprint module is subjected, preventing the fingerprint module from being broken when the electronic device is subjected to the external impact, and preventing the fingerprint module from being damaged.

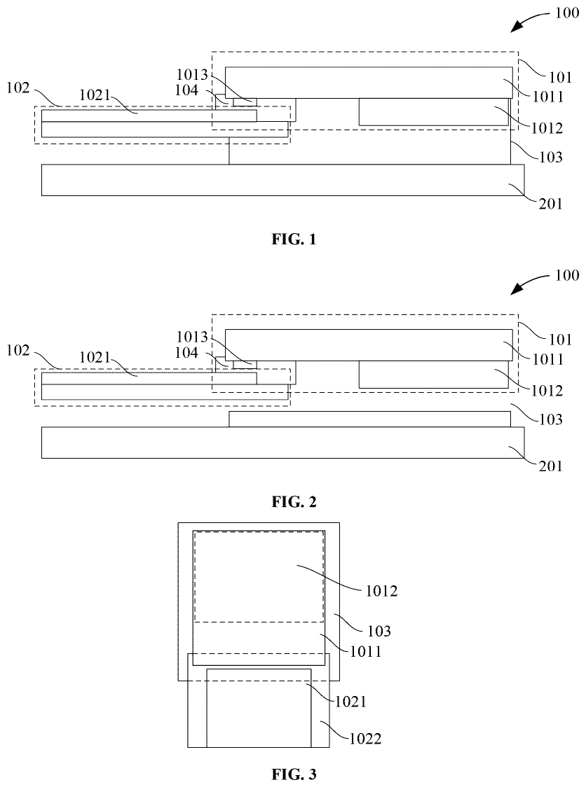

FIG. 1 is a schematic diagram of a fingerprint module provided in an embodiment of the present disclosure, and the fingerprint module is applied to an electronic device. As shown in FIG. 1, the fingerprint module 100 comprises: an ultrasonic sensor 101, a circuit board 102, and a buffer layer 103. The ultrasonic sensor 101 comprises a substrate 1011 and an ultrasonic module 1012. The ultrasonic module 1012 is arranged on the substrate 1011, the substrate 1011 is provided with a first electrical connection area 1013, the circuit board 102 is provided with a second electrical connection area 1021, the first electrical connection area 1013 is electrically connected to the second electrical connection area 1021 through a conductive adhesive layer 104, and the buffer layer 103 is arranged between the ultrasonic sensor 101 and a support structure 201 on the electronic device.

The circuit board 102 is electrically connected to a processing unit of the electronic device, the ultrasonic module 1012 is configured to transmit an ultrasonic signal and receive an ultrasonic signal reflected from an external structure, and the ultrasonic sensor 101 is configured to convert the ultrasonic signal received by the ultrasonic module 1012 into an electrical signal, and send the electrical signal to the processing unit through the circuit board 102, so that the processing unit performs fingerprint recognition based on the electrical signal.

The fingerprint module 100 comprises an ultrasonic sensor 101, a circuit board 102, and a buffer layer 103. The ultrasonic sensor 101 comprises a substrate 1011 and an ultrasonic module 1012, the substrate 1011 is provided with the first electrical connection area 1013, the first electrical connection area 1013 and the ultrasonic module 1012 are located at different positions on the substrate 1011, the circuit board 102 is provided with the second electrical connection area 1021, and the first electrical connection area 1013 is electrically connected to the second electrical connection area 1021 through the conductive adhesive layer 104. Optionally, the conductive adhesive layer 104 may be any structure of a conductive adhesive layer 104, for example, may be conductive adhesive. In some optional embodiments, the conductive adhesive layer 104 may be an Anisotropic Conductive Film (ACF).

The buffer layer 103 is arranged between the ultrasonic sensor 101 and the support structure 201 of the electronic device. When the electronic device is subjected to an external impact, for example, the electronic device is subjected to a mechanical impact or falls off, the buffer layer 103 buffers the fingerprint module 100, reduces a stress to which the fingerprint module 100 is subjected, and prevents the fingerprint module 100 from being damaged.

In an embodiment of the present disclosure, the fingerprint module 100 comprises an ultrasonic sensor 101, a circuit board 102, and a buffer layer 103, wherein the buffer layer 103 is arranged between the ultrasonic sensor 101 and a support structure 201 on the electronic device, so that when the electronic device is subjected to the external impact, the fingerprint module 100 can be buffered through the buffer layer 103, thereby reducing the stress to which the fingerprint module 100 is subjected, preventing the fingerprint module 100 from being broken when the electronic device is subjected to the external impact, and preventing the fingerprint module 100 from being damaged.

In a possible implementation, as shown in FIG. 1, a projection of the ultrasonic module 1012 on the buffer layer 103 along a direction perpendicular to the substrate 1011 is located within an edge of the buffer layer 103; and a projection of the second electrical connection area 1021 along the direction perpendicular to the substrate 1011 intersects with the buffer layer 103.

In the direction perpendicular to the substrate 1011, i.e., in a direction perpendicular to the horizontal plane in FIG. 1, the projection of the ultrasonic module 1012 is located within the edge of the buffer layer 103. The buffer layer 103 is located between the ultrasonic module 1012 and the support structure 201, and is larger in size than the ultrasonic module 1012. In the structure as shown in FIG. 1, left and right edges of a vertical projection of the ultrasonic module 1012 are located between left and right edges of the buffer layer 103, and do not exceed the edges of the buffer layer 103. The projection of the second electrical connection area 1021 provided on the circuit board 102 in the direction perpendicular to the substrate 1011, i.e., in the direction perpendicular to the horizontal plane in FIG. 1, intersects with the buffer layer 103, i.e., a vertical projection of the second electrical connection area 1021 is at least partially located within the left edge of the buffer layer 103 in the structure shown in FIG. 1.

In an embodiment of the present disclosure, the buffer layer 103 is arranged between the circuit board 102 and the support structure 201 and between the ultrasonic module 1012 and the support structure, so that when the electronic device is impacted, the circuit board 102 and the ultrasonic module 1012 of the fingerprint module 100 can be buffered through the buffer layer 103 to prevent the fingerprint module 100 from being damaged because the circuit board 102 and the ultrasonic module 1012 are subjected to a large stress.

In a possible implementation, as shown in FIG. 1, the buffer layer 103 contacts the circuit board 102 and the ultrasonic module 1012 along the direction perpendicular to the substrate 1011.

It should be understood that by arranging the buffer layer 103 with a large height on the support structure 201, the circuit board 102 in the fingerprint module 100 applies a downward force to the buffer layer 103 to compact the buffer layer 103, and the ultrasonic module 1012 in the fingerprint module 100 applies a downward force to the buffer layer 103 to compact the buffer layer 103, so that the buffer layer 103 contacts the circuit board 102 and the ultrasonic module 1012.

In an embodiment of the present disclosure, the buffer layer 103 contacts the circuit board 102 and the ultrasonic module 1012 along the direction perpendicular to the substrate 1011, thereby protecting the circuit board 102 and the ultrasonic module 1012. When the electronic device is subjected to the external impact, the circuit board 102 and the ultrasonic module 1012 can be buffered to prevent the circuit board 102 and the ultrasonic module 1012 from being damaged, thereby effectively protecting the fingerprint module 100.

FIG. 2 is a schematic diagram of another fingerprint module provided in an embodiment of the present disclosure. As shown in FIG. 2, along the direction perpendicular to the substrate 1011, there is a first gap between the buffer layer 103 and the circuit board 102, and there is a second gap between the buffer layer 103 and the ultrasonic module 1012.

In an embodiment of the present disclosure, the first gap is between the buffer layer 103 and the circuit board 102, and the second gap is between the buffer layer 103 and the ultrasonic module 1012, so that when the electronic device is subjected to an external impact, the force of the external impact can be absorbed by the first gap and the second gap, thereby reducing the force of the external impact transmitted to the circuit board 102 and the ultrasonic module 1012 in the fingerprint module 100, reducing a stress to which the structure of the fingerprint module 100 is subjected, preventing the fingerprint module 100 from being broken under the impact of the external force, preventing the circuit board 102 and the ultrasonic module 1012 from being damaged, effectively protecting the fingerprint module 100, and improving the performance of the ultrasonic module 1012 in receiving and sending ultrasonic signals because the buffer layer 103 does not contact the ultrasonic module 1012.

FIG. 3 is a schematic top view of a fingerprint module provided in an embodiment of the present disclosure. As shown in FIG. 3, corresponding to the fingerprint module 100 shown in FIGS. 1 and 2, a projection of the ultrasonic module 1012 on the buffer layer 103 along a direction perpendicular to the substrate 1011 is located within an edge of the buffer layer 103, and a projection of the second electrical connection area 1021 along the direction perpendicular to the substrate 1011 intersects with the buffer layer 103.

FIG. 4 is a schematic diagram of still another fingerprint module provided in an embodiment of the present disclosure. As shown in FIG. 4, a projection of the ultrasonic module 1012 on the buffer layer 103 along a direction perpendicular to the substrate 1011 is located within an edge of the buffer layer 103, and a projection of the second electrical connection area 1021 along the direction perpendicular to the substrate 1011 does not intersect with the buffer layer 103.

In the direction perpendicular to the substrate 1011, i.e., in a direction perpendicular to the horizontal plane in FIG. 4, the projection of the ultrasonic module 1012 is located within the edge of the buffer layer 103. The buffer layer 103 is located between the ultrasonic module 1012 and the support structure 201, and is larger in size than the ultrasonic module 1012. In the structure shown in FIG. 4, left and right edges of a vertical projection of the ultrasonic module 1012 are located between left and right edges of the buffer layer 103, and do not exceed the edges of the buffer layer 103. The projection of the second electrical connection arca 1021 provided on the circuit board 102 in the direction perpendicular to the substrate 1011, i.e., in the direction perpendicular to the horizontal plane in FIG. 4, does not intersect with the buffer layer 103, i.e., right edge of a vertical projection of the second electrical connection area 1021 is located outside left edge of the buffer layer 103 in the structure shown in FIG. 4, and the vertical projection of the second electrical connection area 1021 is not located in the buffer layer 103.

In an embodiment of the present disclosure, the projection of the ultrasonic module 1012 in the ultrasonic sensor 101 on the buffer layer 103 along the direction perpendicular to the substrate 1011 in the ultrasonic sensor 101 is located within the edge of the buffer layer 103, and the projection of the second electrical connection area 1021 provided on the circuit board 102 along the direction perpendicular to the substrate 1011 does not intersect with the buffer layer 103. When the buffer layer 103 buffers the fingerprint module 100, a stress to which the circuit board 102 in the fingerprint module 100 is subjected can be reduced while protecting the ultrasonic module 1012, thereby preventing the fingerprint module 100 from being broken because the circuit board 102 and the ultrasonic module 1012 in the fingerprint module 100 are subjected to a large stress simultaneously when the buffer layer 103 buffers the fingerprint module 100, and effectively protecting the fingerprint module 100.

In a possible implementation, as shown in FIG. 4, the circuit board 102 comprises a base material 1022 and the second electrical connection area 1021 arranged on the base material 1022, the base material 1022 exceeds the second electrical connection area 1021 at one terminal of the circuit board 102 close to the ultrasonic module 1012, and a projection of the base material 1022 along the direction perpendicular to the substrate 1011 intersects with the buffer layer 103.

The circuit board 102 comprises the base material 1022 and the second electrical connection area 1021 formed on the base material 1022. In the structure shown in FIG. 4, the right edge of the second electrical connection area 1021 is located on the left side of the right edge of the base material 1022. In a direction parallel to the substrate 1011, the base material 1022 at one terminal close to the ultrasonic module 1012 at least partially exceeds the second electrical connection area 1021, i.e., the projection of the second electrical connection area 1021 along the direction perpendicular to the substrate 1011 is located within an edge of the projection of the base material 1022 along the direction perpendicular to the substrate 1011.

As shown in FIG. 4, right edge of a vertical projection of the base material 1022 at least partially exceeds the left edge of the buffer layer 103, i.e., the projection of the base material 1022 along the direction perpendicular to the substrate 1011 intersects with the buffer layer 103. It should be understood that the right edge of the vertical projection of the base material 1022 at least partially exceeds the left edge of the buffer layer 103, but the right edge of the vertical projection of the second electrical connection area 1021 is located on the left side of the left edge of the buffer layer 103, i.e., the projection of the second electrical connection area 1021 along the direction perpendicular to the substrate 1011 does not intersect with the buffer layer 103.

In an embodiment of the present disclosure, the projection of the base material 1022 included in the circuit board 102 along the direction perpendicular to the substrate 1011 intersects with the buffer layer 103, so that when the electronic device is impacted, the circuit board 102 of the fingerprint module 100 can be buffered through the buffer layer 103, and the projection of the second electrical connection area 1021 along the direction perpendicular to the substrate 1011 does not intersect with the buffer layer 103, thereby reducing a stress to which the circuit board 102 is subjected, and preventing the fingerprint module 100 from being broken because the circuit board 102 and the ultrasonic module 1012 are subjected to a high stress simultaneously, while buffering and protecting the circuit board 102.

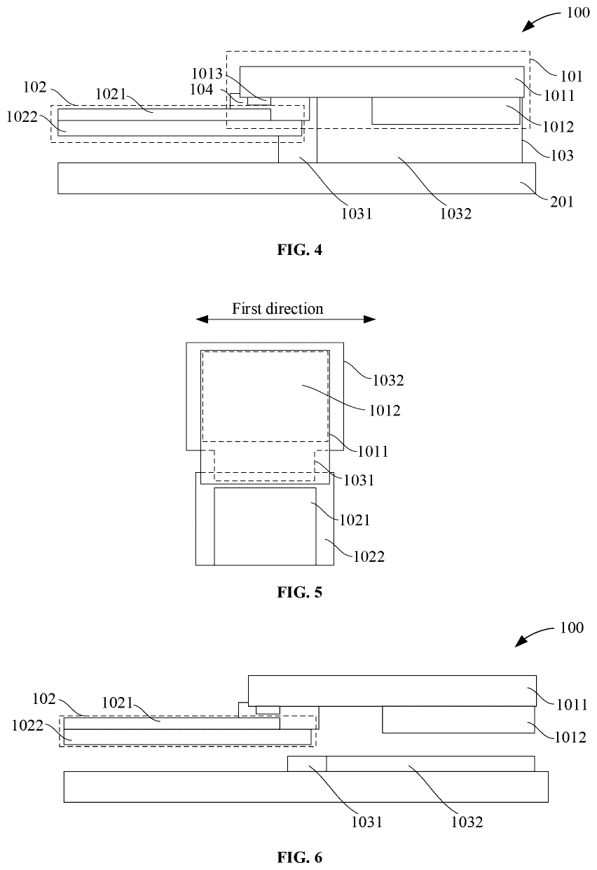

FIG. 5 is a schematic top view of another fingerprint module provided in an embodiment of the present disclosure. As shown in FIG. 5, the buffer layer 103 comprises a first buffer layer 1031 and a second buffer layer 1032 connected to each other, a projection of the first buffer layer 1031 on the substrate 1011 along the direction perpendicular to the substrate 1011 is located within an edge of the substrate 1011 in a first direction, a projection of the base material 1022 along the direction perpendicular to the substrate 1011 intersects with the first buffer layer 1031, and a projection of the ultrasonic module 1012 on the second buffer layer 1032 along the direction perpendicular to the substrate 1011 is located within an edge of the second buffer layer 1032, wherein the first direction is perpendicular to a direction of the circuit board 102 pointing to the ultrasonic module 1012 and perpendicular to the substrate 1011.

As shown in FIG. 5, the buffer layer 103 comprises a first buffer layer 1031 and a second buffer layer 1032, the first buffer layer 1031 is connected to the second buffer layer 1032, the first buffer layer 1031 is smaller in size than the second buffer layer 1032, i.e., the first buffer layer 1031 and the second buffer layer 1032 form a convex structure, and the projection of the first buffer layer 1031 on the substrate 1011 in the direction perpendicular to the substrate 1011 is within the edge of the substrate 1011 in the first direction. In the front view shown in FIG. 4, the first direction is a direction pointing from outside the image to inside the image, is perpendicular to the direction of the circuit board 102 pointing to the ultrasonic module 1012, and is perpendicular to the substrate 1011.

The projection of the base material 1022 in the circuit board 102 along the direction perpendicular to the substrate 1011 intersects with the first buffer layer 1031, i.e., in the structure shown in FIG. 4, the first buffer layer 1031 is at least partially located between the base material 1022 and the support structure 201, and the projection of the ultrasonic module 1012 on the second buffer layer 1032 along the direction perpendicular to the substrate 1011 is located within the edge of the second buffer layer 1032, i.e., in the structure shown in FIG. 4, the second buffer layer 1032 is located between the ultrasonic module 1012 and the support structure 201, and the second buffer layer 1032 is larger in size than the ultrasonic module 1012. It should be understood that the projection of the ultrasonic module 1012 along the direction perpendicular to the substrate 1011 does not intersect with the first buffer layer 1031, i.e., in the structure shown in FIG. 4, the first buffer layer 1031 is not located between the ultrasonic module 1012 and the support structure 201.

In an embodiment of the present disclosure, the buffer layer 103 comprises a first buffer layer 1031 and a second buffer layer 1032 connected to each other, the projection of the first buffer layer 1031 on the substrate 1011 along the direction perpendicular to the substrate 1011 is located within the edge of the substrate 1011 in the first direction, the projection of the base material 1022 along the direction perpendicular to the substrate 1011 intersects with the first buffer layer 1031, and the projection of the ultrasonic module 1012 on the second buffer layer 1032 along the direction perpendicular to the substrate 1011 is located within the edge of the second buffer layer 1032, thereby avoiding impacting the substrate 1011 on the premise of protecting the circuit board 102 in the fingerprint module 100, preventing the edge of the substrate 1011 from being subjected to a large stress because the first buffer layer 1031 is kept away from the edge of the substrate 1011, preventing the fingerprint module 100 from being broken because the electronic device is impacted by an external force, and effectively protecting the fingerprint module 100.

In a possible implementation, as shown in FIG. 4, along the direction perpendicular to the substrate 1011, the first buffer layer 1031 contacts the base material 1022, and the second buffer layer 1032 contacts the ultrasonic module 1012.

It should be understood that the buffer layer 103 composed of the first buffer layer 1031 and the second buffer layer 1032 is a convex polyhedral structure, and the first buffer layer 1031 and the second buffer layer 1032 have an equal height along the direction perpendicular to the substrate 1011. By arranging the first buffer layer 1031 and the second buffer layer 1032 with a large height on the support structure 201, the base material 1022 in the circuit board 102 applies a downward force to the first buffer layer 1031 to compact the first buffer layer 1031, and the ultrasonic module 1012 in the fingerprint module 100 applies a downward force to the second buffer layer 1032 to compact the second buffer layer 1032, so that the first buffer layer 1031 contacts the base material 1022, and the second buffer layer 1032 contacts the ultrasonic module 1012.

It should be noted that, as shown in FIG. 4, since the first buffer layer 1031 and the second buffer layer 1032 are connected as an integral structure, at least a part of the first buffer layer 1031 and/or the second buffer layer 1032 contacts other structures formed on the substrate 1011 except for the ultrasonic module 1012, which will not be repeated here.

In an embodiment of the present disclosure, along the direction perpendicular to the substrate 1011, the first buffer layer 1031 contacts the base material 1022, and the second buffer layer 1032 contacts the ultrasonic module 1012, thereby protecting the circuit board 102 and the ultrasonic module 1012. The first buffer layer 1031 is kept away from the edge of the substrate 1011, thereby preventing, when the electronic device is subjected to an external impact, the edge of the substrate 1011 from being subjected to a large stress, and preventing the fingerprint module 100 from being broken under the impact of the external force. Further, the first buffer layer 1031 contacts the base material 1022, and the second buffer layer 1032 contacts the ultrasonic module 1012, thereby buffering the circuit board 102 and the ultrasonic module 1012, preventing the circuit board 102 and the ultrasonic module 1012 from being damaged, and effectively protecting the fingerprint module 100.

FIG. 6 is a schematic diagram of yet another fingerprint module provided in an embodiment of the present disclosure. As shown in FIG. 6, along the direction perpendicular to the substrate 1011, there is a third gap between the first buffer layer 1031 and the base material 1022, and there is a fourth gap between the second buffer layer 1032 and the ultrasonic module 1012.

In some optional embodiments, the first buffer layer 1031 and the second buffer layer 1032 have an equal height along the direction perpendicular to the substrate 1011, and it should be understood that since the circuit board 102 and the ultrasonic module 1012 have inconsistent heights, the third gap and the fourth gap have different heights in the direction perpendicular to the substrate 1011.

In an embodiment of the present disclosure, the third gap is between the first buffer layer 1031 and the base material 1022, and the fourth gap is between the second buffer layer 1032 and the ultrasonic module 1012, so that when the electronic device is subjected to an external impact, the force of the external impact can be absorbed by the third gap and the fourth gap, thereby reducing the force of the external impact transmitted to the circuit board 102 and the ultrasonic module 1012 in the fingerprint module 100, reducing a stress to which the structure of the fingerprint module 100 is subjected, preventing the fingerprint module 100 from being broken under the impact of the external force, preventing the circuit board 102 and the ultrasonic module 1012 from being damaged, effectively protecting the fingerprint module 100, and improving the performance of the ultrasonic module 1012 in receiving and sending ultrasonic signals because the second buffer layer 1032 does not contact the ultrasonic module 1012.

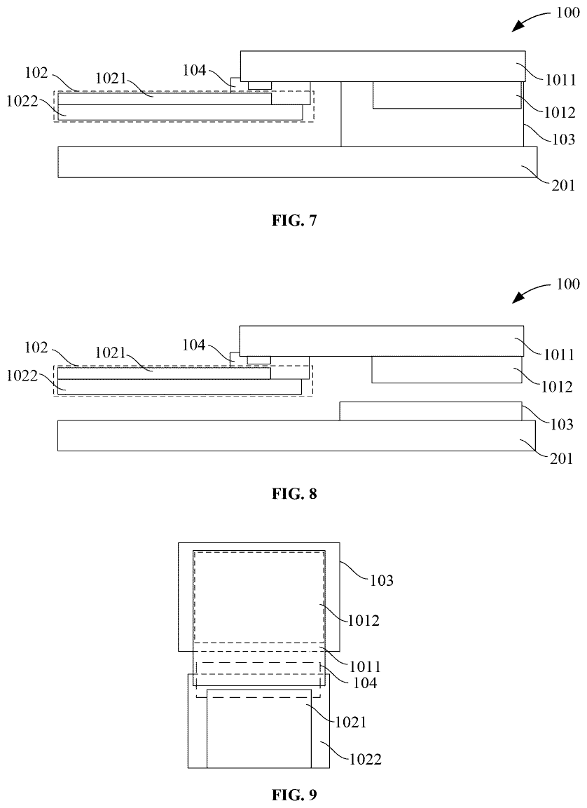

FIG. 7 is a schematic diagram of yet another fingerprint module provided in an embodiment of the present disclosure. As shown in FIG. 7, projections of the circuit board 102 and the conductive adhesive layer 104 along the direction perpendicular to the substrate 1011 do not intersect with the buffer layer 103.

As shown in FIG. 7, the buffer layer 103 may be located only between the ultrasonic module 1012 and the support structure 201, and a projection of the ultrasonic module 1012 on the substrate 1011 along the direction perpendicular to the substrate 1011 is within an edge of the buffer layer 103. In the structure shown in FIG. 7, there is no buffer layer 103 between the circuit board 102 and the support structure 201 and between the conductive adhesive layer 104 and the support structure, so that the projections of the circuit board 102 and the conductive adhesive layer 104 along the direction perpendicular to the substrate 1011 do not intersect with the buffer layer 103, left edge of the projection of the ultrasonic module 1012 in the direction perpendicular to the substrate 1011 is located within left edge of the buffer layer 103, and right edge of the projection of the ultrasonic module 1012 in the direction perpendicular to the substrate 1011 is located within right edge of the buffer layer 103.

In an embodiment of the present disclosure, the projections of the circuit board 102 and the conductive adhesive layer 104 along the direction perpendicular to the substrate 1011 do not intersect with the buffer layer 103, thereby preventing the structure of the fingerprint module 100 between the circuit board 102 and the ultrasonic module from being broken because the circuit board 102 and the ultrasonic module 1012 of the fingerprint module 100 are subjected to a large stress simultaneously when the electronic device is impacted by an external force, and effectively protecting the fingerprint module 100.

In a possible implementation, as shown in FIG. 7, the buffer layer 103 contacts the ultrasonic module 1012 along the direction perpendicular to the substrate 1011.

As shown in FIG. 7, the buffer layer 103 may be a cube or a cuboid structure, and the buffer layer 103 is arranged on the support structure 201 of the electronic device. The ultrasonic module 1012 in the fingerprint module 100 applies a downward force to the buffer layer 103 to compact the buffer layer 103, so that the buffer layer 103 contacts the ultrasonic module 1012.

In an embodiment of the present disclosure, the buffer layer 103 contacts the ultrasonic module 1012 along the direction perpendicular to the substrate 1011, so that the ultrasonic module 1012 can be wrapped by the buffer layer 103 to protect the ultrasonic module 1012, and the ultrasonic module 1012 can be protected from being damaged when the electronic device is subjected to an external impact. Further, the buffer layer 103 is not provided at a corresponding position of the circuit board 102, thereby preventing the circuit board 102 and the ultrasonic module 1012 from being subjected to a high stress simultaneously, preventing the fingerprint module 100 from being broken, and effectively protecting the fingerprint module 100.

FIG. 8 is a schematic diagram of yet another fingerprint module provided in an embodiment of the present disclosure. As shown in FIG. 8, there is a fifth gap between the buffer layer 103 and the ultrasonic module 1012 along the direction perpendicular to the substrate 1011.

In the structure shown in FIG. 8, the buffer layer 103 may be a cube or a cuboid structure, the buffer layer 103 is arranged between the ultrasonic module 1012 and the support structure 201, and the projections of the circuit board 102 and the conductive adhesive layer 104 along the direction perpendicular to the substrate 1011 do not intersect with the buffer layer 103, that is, the buffer layer 103 is only arranged between the ultrasonic module 1012 and the support structure 201, the buffer layer 103 does not contact the ultrasonic module 1012, and the fifth gap is between the buffer layer 103 and the ultrasonic module 1012.

FIG. 9 is a schematic top view of still another fingerprint module provided in an embodiment of the present disclosure. As shown in FIG. 9, in the fingerprint module 100 shown in FIGS. 7 and 8, the buffer layer 103 is only arranged between the ultrasonic module 1012 and the support structure 201, and there is no buffer layer 103 between the support structure 201 and each of the base material 1022, the second electrical connection area 1021 and the conductive adhesive layer 104.

In an embodiment of the present disclosure, along the direction perpendicular to the substrate 1011, there is a fifth gap between the buffer layer 103 and the ultrasonic module 1012, and a force of an external impact is absorbed by the fifth gap, thereby reducing the external impact from transmission to the ultrasonic module 1012 in the fingerprint module 100, reducing a stress to which the ultrasonic module 1012 is subjected, and preventing the ultrasonic module 1012 from being damaged. Further, the buffer layer 103 is not provided at a corresponding position of the circuit board 102, thereby preventing the circuit board 102 and the ultrasonic module 1012 from being subjected to a high stress simultaneously, preventing the fingerprint module 100 from being broken, and effectively protecting the fingerprint module 100. Further, the buffer layer 103 does not contact the ultrasonic module 1012, thereby improving the performance of the ultrasonic module 1012 in receiving and sending ultrasonic signals.

In a possible implementation, the buffer layer 103 comprises a buffer foam having a density in a range of [0.01 g/cm³, 0.5 g/cm³].

In an embodiment of the present disclosure, the buffer layer 103 comprises a buffer foam having the density in the range of [0.01 g/cm³, 0.5 g/cm³], thereby buffering the fingerprint module 100 through the buffer layer 103. The density of the buffer layer 103 is in the range of [0.01 g/cm³, 0.5 g/cm³], thereby preventing the buffer layer 103 from affecting the ultrasonic module 1012 in receiving and sending ultrasonic signals, and adapting to protecting the ultrasonic module 1012.

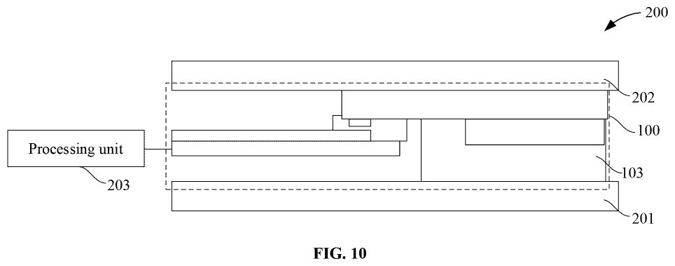

FIG. 10 is a schematic diagram of an electronic device provided in an embodiment of the present disclosure. As shown in FIG. 10, the electronic device 200 comprises a processing unit 203, a screen 202, a support structure 201, and the fingerprint module 100 in any one of the above embodiments. The fingerprint module 100 is arranged between the screen 202 and the support structure 201, a buffer layer 103 in the fingerprint module 100 is arranged between the ultrasonic sensor in the fingerprint module 100 and the support structure 201, the processing unit 203 is electrically connected to the fingerprint module 100, and the processing unit 203 is configured to perform fingerprint recognition based on an electrical signal transmitted from the fingerprint module 100.

In an embodiment of the present disclosure, the fingerprint module 100 is arranged between the screen 202 and the support structure 201, and the buffer layer 103 in the fingerprint module 100 is arranged between the ultrasonic sensor in the fingerprint module 100 and the support structure 201, thereby protecting the fingerprint module 100 through the buffer layer 103 when the electronic device 200 is subjected to an external impact, preventing the fingerprint module 100 from being broken because the structure of the fingerprint module 100 is subjected to a large stress when the buffer layer 103 buffers the fingerprint module 100, and effectively protecting the fingerprint module 100.

In a possible implementation, the support structure 201 comprises a middle frame or a battery of the electronic device 200.

In an embodiment of the present disclosure, the support structure 201 of the electronic device 200 is the middle frame or the battery of the electronic device 200, thereby arranging the fingerprint module 100 between the screen 202 and the support structure 201, arranging the buffer layer 103 on the support structure 201 to buffer the fingerprint module 100, and effectively protecting the fingerprint module 100.

It should be noted that, depending on the implementation requirements, the components/steps described in the embodiments of the present disclosure may be split into more components/steps, or two or more components/steps or partial operations of the components/steps may be combined into novel components/steps to achieve the goal of the embodiments of the present disclosure.

As will be appreciated by those of ordinary skills in the art, the various example units and method steps described in combination with the embodiments disclosed herein can be implemented by electronic hardware, or a combination of computer software and electronic hardware. Whether these functions are executed by hardware or software depends on particular applications and design constraints of the technical solutions. Those skilled in the art may implement the described functions for each particular application using different methods, but such implementation should not be considered as falling beyond the scope of the embodiments of the present disclosure.

The above embodiments are only used to illustrate the embodiments of the present disclosure, and are not intended to limit the embodiments of the present disclosure. Those of ordinary skills in the relevant technical field may further make various alterations and modifications without departing from the spirit and scope of the embodiments of the present disclosure. Therefore, all equivalent technical solutions are also encompassed within the scope of the embodiments of the present disclosure, and the scope of patent protection of the embodiments of the present disclosure should be defined by the claims.

1. A fingerprint module, applied to an electronic device and comprising: an ultrasonic sensor, a circuit board, and a buffer layer; wherein
the ultrasonic sensor comprises a substrate and an ultrasonic module, the ultrasonic module is arranged on the substrate, the substrate is provided with a first electrical connection area, the circuit board is provided with a second electrical connection area, the first electrical connection area is electrically connected to the second electrical connection area through a conductive adhesive layer;
the buffer layer is arranged between the ultrasonic sensor and a support structure of the electronic device; and
the circuit board is electrically connected to a processing unit of the electronic device, the ultrasonic module is configured to transmit an ultrasonic signal and receive an ultrasonic signal reflected from an external structure, and the ultrasonic sensor is configured to convert the ultrasonic signal received by the ultrasonic module into an electrical signal, and send the electrical signal to the processing unit through the circuit board, so that the processing unit performs fingerprint recognition based on the electrical signal.

2. The fingerprint module according to claim 1, wherein
a projection of the ultrasonic module on the buffer layer along a direction perpendicular to the substrate is located within an edge of the buffer layer; and
a projection of the second electrical connection area along the direction perpendicular to the substrate intersects with the buffer layer.

3. The fingerprint module according to claim 2, wherein the buffer layer contacts the circuit board and the ultrasonic module along the direction perpendicular to the substrate.

4. The fingerprint module according to claim 2, wherein, along the direction perpendicular to the substrate, there is a first gap between the buffer layer and the circuit board, and there is a second gap between the buffer layer and the ultrasonic module.

5. The fingerprint module according to claim 1, wherein
a projection of the ultrasonic module on the buffer layer along a direction perpendicular to the substrate is located within an edge of the buffer layer; and
a projection of the second electrical connection area along the direction perpendicular to the substrate does not intersect with the buffer layer.

6. The fingerprint module according to claim 5, wherein the circuit board comprises a base material and the second electrical connection area arranged on the base material, the base material exceeds the second electrical connection area at one terminal of the circuit board close to the ultrasonic module, and a projection of the base material along the direction perpendicular to the substrate intersects with the buffer layer.

7. The fingerprint module according to claim 6, wherein the buffer layer comprises a first buffer layer and a second buffer layer connected to each other, a projection of the first buffer layer on the substrate along the direction perpendicular to the substrate is located within an edge of the substrate in a first direction, a projection of the base material along the direction perpendicular to the substrate intersects with the first buffer layer, and a projection of the ultrasonic module on the second buffer layer along the direction perpendicular to the substrate is located within an edge of the second buffer layer, wherein the first direction is perpendicular to a direction of the circuit board pointing to the ultrasonic module and perpendicular to the substrate.

8. The fingerprint module according to claim 7, wherein along the direction perpendicular to the substrate, the first buffer layer contacts the base material, and the second buffer layer contacts the ultrasonic module.

9. The fingerprint module according to claim 7, wherein along the direction perpendicular to the substrate, there is a third gap between the first buffer layer and the base material, and there is a fourth gap between the second buffer layer and the ultrasonic transmission module.

10. The fingerprint module according to claim 5, wherein projections of the circuit board and the conductive adhesive layer along the direction perpendicular to the substrate do not intersect with the buffer layer.

11. The fingerprint module according to claim 10, wherein the buffer layer contacts the ultrasonic module along the direction perpendicular to the substrate.

12. The fingerprint module according to claim 10, wherein there is a fifth gap between the buffer layer and the ultrasonic module along the direction perpendicular to the substrate.

13. The fingerprint module according to claim 1, wherein the buffer layer comprises a buffer foam having a density in a range of [0.01 g/cm^{3,} 0.5 g/cm³].

14. An electronic device, comprising: a processing unit, a screen, a support structure, and a fingerprint module, and the fingerprint module comprising: an ultrasonic sensor, a circuit board, and a buffer layer; wherein
the ultrasonic sensor comprises a substrate and an ultrasonic module, the ultrasonic module is arranged on the substrate, the substrate is provided with a first electrical connection area, the circuit board is provided with a second electrical connection area, the first electrical connection area is electrically connected to the second electrical connection area through a conductive adhesive layer;
the buffer layer is arranged between the ultrasonic sensor and a support structure of the electronic device; and
the circuit board is electrically connected to a processing unit of the electronic device, the ultrasonic module is configured to transmit an ultrasonic signal and receive an ultrasonic signal reflected from an external structure, and the ultrasonic sensor is configured to convert the ultrasonic signal received by the ultrasonic module into an electrical signal, and send the electrical signal to the processing unit through the circuit board, so that the processing unit performs fingerprint recognition based on the electrical signal,
the fingerprint module is arranged between the screen and the support structure, and a buffer layer in the fingerprint module is arranged between an ultrasonic sensor in the fingerprint module and the support structure, wherein the support structure comprises a middle frame and/or a battery of the electronic device;
the processing unit is electrically connected to the fingerprint module; and
the processing unit is configured to perform fingerprint recognition based on an electrical signal transmitted from the fingerprint module.

15. The electronic device according to claim 14, wherein
a projection of the ultrasonic module on the buffer layer along a direction perpendicular to the substrate is located within an edge of the buffer layer; and
a projection of the second electrical connection area along the direction perpendicular to the substrate intersects with the buffer layer.

16. The electronic device according to claim 15, wherein the buffer layer contacts the circuit board and the ultrasonic module along the direction perpendicular to the substrate.

17. The electronic device fingerprint module according to claim 15, wherein, along the direction perpendicular to the substrate, there is a first gap between the buffer layer and the circuit board, and there is a second gap between the buffer layer and the ultrasonic module.

18. The electronic device according to claim 14, wherein
a projection of the ultrasonic module on the buffer layer along a direction perpendicular to the substrate is located within an edge of the buffer layer; and
a projection of the second electrical connection area along the direction perpendicular to the substrate does not intersect with the buffer layer.

19. The electronic device according to claim 18, wherein the circuit board comprises a base material and the second electrical connection area arranged on the base material, the base material exceeds the second electrical connection area at one terminal of the circuit board close to the ultrasonic module, and a projection of the base material along the direction perpendicular to the substrate intersects with the buffer layer.

20. The electronic device according to claim 19, wherein the buffer layer comprises a first buffer layer and a second buffer layer connected to each other, a projection of the first buffer layer on the substrate along the direction perpendicular to the substrate is located within an edge of the substrate in a first direction, a projection of the base material along the direction perpendicular to the substrate intersects with the first buffer layer, and a projection of the ultrasonic module on the second buffer layer along the direction perpendicular to the substrate is located within an edge of the second buffer layer, wherein the first direction is perpendicular to a direction of the circuit board pointing to the ultrasonic module and perpendicular to the substrate.
